(19) United States
(12) Patent Application Publication
(10) Pub. No.: US 2026/0088956 A1
(43) Pub. Date: Mar. 26, 2026

(54) VIRTUAL FLUID DEMODULATION REFERENCE SIGNAL PATTERN FOR DATA TRANSMISSIONS

(71) Applicant: QUALCOMM Incorporated, San Diego, CA (US)

(72) Inventors: Chih-Hao LIU, San Diego, CA (US); Jing SUN, San Diego, CA (US); Somsubhra BARIK, San Diego, CA (US)

(21) Appl. No.: 18/898,562

(22) Filed: Sep. 26, 2024

(51) Int. Cl. H04L 5/00; H04W 72/232

(52) U.S. Cl. CPC H04L 5/0051; H04W 72/232

(57) ABSTRACT

Methods, systems, and devices for wireless communications are described. According to the techniques described herein, a network entity may indicate a DMRS pattern starting from a first SLIV of a long data burst, a starting offset, and a symbol spacing between consecutive DMRS symbols. The network entity may signal these parameters via radio resource control (RRC) signaling. The network entity may then send a first DCI to indicate a start of the DMRS pattern and a last DCI to indicate the end of the DMRS pattern.

### FIELD OF TECHNOLOGY

The following relates to wireless communications, including a virtual fluid demodulation reference signal pattern for data transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving configuration information that identifies a demodulation reference signal (DMRS) pattern, the DMRS pattern associated with a starting symbol offset of a first DMRS in the DMRS pattern, a quantity of symbols between each DMRS in the DMRS pattern, and a last symbol offset of a last DMRS in the DMRS pattern, receiving a first downlink control information (DCI) that indicates a first start and length indicator value (SLIV) for a first data transmission, receiving a last DCI that indicates a last SLIV for a last data transmission that is scheduled to occur after the first data transmission, and receiving a set of multiple DMRSs over a set of multiple slots in accordance with the DMRS pattern, the set of multiple DMRSs including the first DMRS, the last DMRS, and one or more additional DMRSs received after the first DMRS and before the last DMRS, where the first DMRS is received in accordance with the starting symbol offset with respect to the first SLIV, and where the last DMRS is received in accordance with the last symbol offset with respect to the last SLIV.

A UE for wireless communications is described. The UE may include one or more memories storing processor executable code, and one or more processors coupled with the one or more memories. The one or more processors may individually or collectively be operable to execute the code to cause the UE to receive configuration information that identifies a DMRS pattern, the DMRS pattern associated with a starting symbol offset of a first DMRS in the DMRS pattern, a quantity of symbols between each DMRS in the DMRS pattern, and a last symbol offset of a last DMRS in the DMRS pattern, receive a first DCI that indicates a first start and length indicator value (SLIV) for a first data transmission, receive a last DCI that indicates a last SLIV for a last data transmission that is scheduled to occur after the first data transmission, and receive a set of multiple DMRSs over a set of multiple slots in accordance with the DMRS pattern, the set of multiple DMRSs including the first DMRS, the last DMRS, and one or more additional DMRSs received after the first DMRS and before the last DMRS, where the first DMRS is received in accordance with the starting symbol offset with respect to the first SLIV, and where the last DMRS is received in accordance with the last symbol offset with respect to the last SLIV.

Another UE for wireless communications is described. The UE may include means for receiving configuration information that identifies a DMRS pattern, the DMRS pattern associated with a starting symbol offset of a first DMRS in the DMRS pattern, a quantity of symbols between each DMRS in the DMRS pattern, and a last symbol offset of a last DMRS in the DMRS pattern, means for receiving a first DCI that indicates a first start and length indicator value (SLIV) for a first data transmission, means for receiving a last DCI that indicates a last SLIV for a last data transmission that is scheduled to occur after the first data transmission, and means for receiving a set of multiple DMRSs over a set of multiple slots in accordance with the DMRS pattern, the set of multiple DMRSs including the first DMRS, the last DMRS, and one or more additional DMRSs received after the first DMRS and before the last DMRS, where the first DMRS is received in accordance with the starting symbol offset with respect to the first SLIV, and where the last DMRS is received in accordance with the last symbol offset with respect to the last SLIV.

A non-transitory computer-readable medium storing code for wireless communications is described. The code may include instructions executable by one or more processors to receive configuration information that identifies a DMRS pattern, the DMRS pattern associated with a starting symbol offset of a first DMRS in the DMRS pattern, a quantity of symbols between each DMRS in the DMRS pattern, and a last symbol offset of a last DMRS in the DMRS pattern, receive a first DCI that indicates a first start and length indicator value (SLIV) for a first data transmission, receive a last DCI that indicates a last SLIV for a last data transmission that is scheduled to occur after the first data transmission, and receive a set of multiple DMRSs over a set of multiple slots in accordance with the DMRS pattern, the set of multiple DMRSs including the first DMRS, the last DMRS, and one or more additional DMRSs received after the first DMRS and before the last DMRS, where the first DMRS is received in accordance with the starting symbol offset with respect to the first SLIV, and where the last DMRS is received in accordance with the last symbol offset with respect to the last SLIV.

In some examples of the method, user equipment (UEs), and non-transitory computer-readable medium described herein, the configuration information includes a set of multiple DMRS patterns, each of the DMRS patterns of the set of multiple DMRS patterns associated with respective starting symbol offsets, quantities of symbols between each DMRS, and last symbol offsets and the first DCI indicates the DMRS pattern of the set of multiple DMRS patterns the UE may be to use.

In some examples of the method, user equipment (UEs), and non-transitory computer-readable medium described herein, the first DMRS may be offset in accordance with the starting symbol offset with respect to a beginning symbol indicated by the first SLIV.

In some examples of the method, user equipment (UEs), and non-transitory computer-readable medium described herein, the last DMRS may be offset in accordance with the last symbol offset with respect to a last symbol indicated by the last SLIV.

In some examples of the method, user equipment (UEs), and non-transitory computer-readable medium described herein, a second to last DMRS preceding the last DMRS may be separated by less than the quantity of symbols indicated by the configuration information between each DMRS in the DMRS pattern.

In some examples of the method, user equipment (UEs), and non-transitory computer-readable medium described herein, the first DCI includes one or more fields indicating a beginning of the first data transmission and an activation of the DMRS pattern.

In some examples of the method, user equipment (UEs), and non-transitory computer-readable medium described herein, the first data transmission and the last data transmission may be part of a data transmission burst and a gap of one or more slots exists in the data transmission burst.

Some examples of the method, user equipment (UEs), and non-transitory computer-readable medium described herein may further include operations, features, means, or instructions for receiving an orphan DMRS in accordance with the DMRS pattern during the gap.

In some examples of the method, user equipment (UEs), and non-transitory computer-readable medium described herein, the DMRS pattern may be a first DMRS pattern and the method, apparatuses, and non-transitory computer-readable medium may include further operations, features, means, or instructions for receiving one or more DMRSs in accordance with the second DMRS pattern during one or more slots indicated by a second SLIV immediately after the gap.

Some examples of the method, user equipment (UEs), and non-transitory computer-readable medium described herein may further include operations, features, means, or instructions for receiving a third DCI including one or more fields indicating an activation of the second DMRS pattern.

Some examples of the method, user equipment (UEs), and non-transitory computer-readable medium described herein may further include operations, features, means, or instructions for receiving a DMRS after the last DMRS based on the last DMRS being greater than a threshold quantity of symbols away from a last symbol indicated by the last SLIV.

Some examples of the method, user equipment (UEs), and non-transitory computer-readable medium described herein may further include operations, features, means, or instructions for receiving a third DCI indicating the DMRS after the last DMRS, where a symbol position of the DMRS may be indicated by the DCI.

In some examples of the method, user equipment (UEs), and non-transitory computer-readable medium described herein, the first SLIV indicates a length that spans a set of multiple slots.

In some examples of the method, user equipment (UEs), and non-transitory computer-readable medium described herein, the configuration information may be a radio resource control message.

A method for wireless communications by a network entity is described. The method may include transmitting configuration information that identifies a DMRS pattern, the DMRS pattern associated with a starting symbol offset of a first DMRS in the DMRS pattern, a quantity of symbols between each DMRS in the DMRS pattern, and a last symbol offset of a last DMRS in the DMRS pattern, transmitting a first DCI that indicates a first start and length indicator value (SLIV) for a first data transmission, transmitting a last DCI that indicates a last SLIV for a last data transmission that is scheduled to occur after the first data transmission, and transmitting a set of multiple DMRSs over a set of multiple slots in accordance with the DMRS pattern, the set of multiple DMRSs including the first DMRS, the last DMRS, and one or more additional DMRSs received after the first DMRS and before the last DMRS, where the first DMRS is received in accordance with the starting symbol offset with respect to the first SLIV, and where the last DMRS is transmitted in accordance with the last symbol offset with respect to the last SLIV.

A network entity for wireless communications is described. The network entity may include one or more memories storing processor executable code, and one or more processors coupled with the one or more memories. The one or more processors may individually or collectively be operable to execute the code to cause the network entity to transmit configuration information that identifies a DMRS pattern, the DMRS pattern associated with a starting symbol offset of a first DMRS in the DMRS pattern, a quantity of symbols between each DMRS in the DMRS pattern, and a last symbol offset of a last DMRS in the DMRS pattern, transmit a first DCI that indicates a first start and length indicator value (SLIV) for a first data transmission, transmit a last DCI that indicates a last SLIV for a last data transmission that is scheduled to occur after the first data transmission, and transmit a set of multiple DMRSs over a set of multiple slots in accordance with the DMRS pattern, the set of multiple DMRSs including the first DMRS, the last DMRS, and one or more additional DMRSs received after the first DMRS and before the last DMRS, where the first DMRS is received in accordance with the starting symbol offset with respect to the first SLIV, and where the last DMRS is transmitted in accordance with the last symbol offset with respect to the last SLIV.

Another network entity for wireless communications is described. The network entity may include means for transmitting configuration information that identifies a DMRS pattern, the DMRS pattern associated with a starting symbol offset of a first DMRS in the DMRS pattern, a quantity of symbols between each DMRS in the DMRS pattern, and a last symbol offset of a last DMRS in the DMRS pattern, means for transmitting a first DCI that indicates a first start and length indicator value (SLIV) for a first data transmission, means for transmitting a last DCI that indicates a last SLIV for a last data transmission that is scheduled to occur after the first data transmission, and means for transmitting a set of multiple DMRSs over a set of multiple slots in accordance with the DMRS pattern, the set of multiple DMRSs including the first DMRS, the last DMRS, and one or more additional DMRSs received after the first DMRS and before the last DMRS, where the first DMRS is received in accordance with the starting symbol offset with respect to the first SLIV, and where the last DMRS is transmitted in accordance with the last symbol offset with respect to the last SLIV.

A non-transitory computer-readable medium storing code for wireless communications is described. The code may include instructions executable by one or more processors to transmit configuration information that identifies a DMRS pattern, the DMRS pattern associated with a starting symbol offset of a first DMRS in the DMRS pattern, a quantity of symbols between each DMRS in the DMRS pattern, and a last symbol offset of a last DMRS in the DMRS pattern, transmit a first DCI that indicates a first start and length indicator value (SLIV) for a first data transmission, transmit a last DCI that indicates a last SLIV for a last data transmission that is scheduled to occur after the first data transmission, and transmit a set of multiple DMRSs over a set of multiple slots in accordance with the DMRS pattern, the set of multiple DMRSs including the first DMRS, the last DMRS, and one or more additional DMRSs received after the first DMRS and before the last DMRS, where the first DMRS is received in accordance with the starting symbol offset with respect to the first SLIV, and where the last DMRS is transmitted in accordance with the last symbol offset with respect to the last SLIV.

In some examples of the method, network entities, and non-transitory computer-readable medium described herein, the configuration information includes a set of multiple DMRS patterns, each of the DMRS patterns of the set of multiple DMRS patterns associated with respective starting symbol offsets, quantities of symbols between each DMRS, and last symbol offsets and the first DCI indicates the DMRS pattern of the set of multiple DMRS patterns a user equipment may be to use.

In some examples of the method, network entities, and non-transitory computer-readable medium described herein, the first DMRS may be offset in accordance with the starting symbol offset with respect to a beginning symbol indicated by the first SLIV.

In some examples of the method, network entities, and non-transitory computer-readable medium described herein, the last DMRS may be offset in accordance with the last symbol offset with respect to a last symbol indicated by the last SLIV.

In some examples of the method, network entities, and non-transitory computer-readable medium described herein, a second to last DMRS preceding the last DMRS may be separated by less than the quantity of symbols indicated by the configuration information between each DMRS in the DMRS pattern.

In some examples of the method, network entities, and non-transitory computer-readable medium described herein, the first DCI includes one or more fields indicating a beginning of the first data transmission and an activation of the DMRS pattern.

In some examples of the method, network entities, and non-transitory computer-readable medium described herein, the first data transmission and the last data transmission may be part of a data transmission burst and a gap of one or more slots exists in the data transmission burst.

Some examples of the method, network entities, and non-transitory computer-readable medium described herein may further include operations, features, means, or instructions for transmitting an orphan DMRS in accordance with the DMRS pattern during the gap.

In some examples of the method, network entities, and non-transitory computer-readable medium described herein, the DMRS pattern may be a first DMRS pattern and the method, apparatuses, and non-transitory computer-readable medium may include further operations, features, means, or instructions for transmitting one or more DMRSs in accordance with the second DMRS pattern during one or more slots indicated by a second SLIV immediately after the gap.

Some examples of the method, network entities, and non-transitory computer-readable medium described herein may further include operations, features, means, or instructions for transmitting a third DCI including one or more fields indicating an activation of the second DMRS pattern.

Some examples of the method, network entities, and non-transitory computer-readable medium described herein may further include operations, features, means, or instructions for transmitting a DMRS after the last DMRS based on the last DMRS being greater than a threshold quantity of symbols away from a last symbol indicated by the last SLIV.

Some examples of the method, network entities, and non-transitory computer-readable medium described herein may further include operations, features, means, or instructions for transmitting a third DCI indicating the DMRS after the last DMRS, where a symbol position of the DMRS may be indicated by the DCI.

In some examples of the method, network entities, and non-transitory computer-readable medium described herein, the first SLIV indicates a length that spans a set of multiple slots.

In some examples of the method, network entities, and non-transitory computer-readable medium described herein, the configuration information may be a radio resource control message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports a virtual fluid demodulation reference signal pattern for data transmissions in accordance with one or more aspects of the present disclosure.

FIG. 2 shows an example of a wireless communications system that supports a virtual fluid demodulation reference signal pattern for data transmissions in accordance with one or more aspects of the present disclosure.

FIG. 3 shows an example of a slot diagram that supports a virtual fluid demodulation reference signal pattern for data transmissions in accordance with one or more aspects of the present disclosure.

FIG. 4 shows an example of a slot diagram that supports a virtual fluid demodulation reference signal pattern for data transmissions in accordance with one or more aspects of the present disclosure.

FIG. 5 shows an example of a slot diagram that supports a virtual fluid demodulation reference signal pattern for data transmissions in accordance with one or more aspects of the present disclosure.

FIG. 6 shows an example of a process flow diagram that supports a virtual fluid demodulation reference signal pattern for data transmissions in accordance with one or more aspects of the present disclosure.

FIGS. 7 and 8 show block diagrams of devices that support a virtual fluid demodulation reference signal pattern for data transmissions in accordance with one or more aspects of the present disclosure.

FIG. 9 shows a block diagram of a communications manager that supports a virtual fluid demodulation reference signal pattern for data transmissions in accordance with one or more aspects of the present disclosure.

FIG. 10 shows a diagram of a system including a device that supports a virtual fluid demodulation reference signal pattern for data transmissions in accordance with one or more aspects of the present disclosure.

FIGS. 11 and 12 show block diagrams of devices that support a virtual fluid demodulation reference signal pattern for data transmissions in accordance with one or more aspects of the present disclosure.

FIG. 13 shows a block diagram of a communications manager that supports a virtual fluid demodulation reference signal pattern for data transmissions in accordance with one or more aspects of the present disclosure.

FIG. 14 shows a diagram of a system including a device that supports a virtual fluid demodulation reference signal pattern for data transmissions in accordance with one or more aspects of the present disclosure.

FIGS. 15 and 16 show flowcharts illustrating methods that support a virtual fluid demodulation reference signal pattern for data transmissions in accordance with one or more aspects of the present disclosure.

### DETAILED DESCRIPTION

In some examples of wireless communications, a user equipment (UE) may receive one or more demodulated reference signals (DMRSs) from a network entity. A DMRS is a type of reference signal embedded within a data stream or data channel that the UE may use for channel estimation, synchronization, demodulation purposes, and beamforming. DMRS may be utilized in both uplink and downlink transmissions. In some cases, a network entity may schedule a data transmission with a long start and length indicator value (SLIV) in order to accommodate the transfer of larger chunks of data. This may result in a more efficient use of the spectrum and reduces the overhead associated with numerous smaller transmissions.

In scheduling a data transmission with a number of DMRS shared across a long SLIV, each slot of the SLIV may have different numbers of DMRSs with various symbol locations within the slots. In this instance, scheduling downlink control information (DCI) may dynamically indicate the DMRS locations within a slot, which may result in a large overhead (e.g., a 14 bit bitmap may be required for each slot).

According to the techniques described herein, a network entity may indicate a DMRS pattern starting from a first SLIV of a long data burst, a starting offset, and a symbol spacing between consecutive DMRS symbols. The network entity may signal these parameters via radio resource control (RRC) signaling. The network entity may then send a first DCI to indicate a start of the DMRS pattern and a last DCI to indicate the end of the DMRS pattern. Therefore, no indication per SLIV DMRS pattern is needed to indicate the symbol locations of the DMRS. These techniques may result in lower system overhead and lower latency.

Aspects of the disclosure are initially described in the context of wireless communications systems. Aspects of the disclosure are further illustrated by and described with reference to slot diagrams and process flow diagrams. Aspects of the disclosure are further illustrated by and described with reference to apparatus diagrams, system diagrams, and flowcharts that relate to a virtual fluid demodulation reference signal pattern for data transmissions.

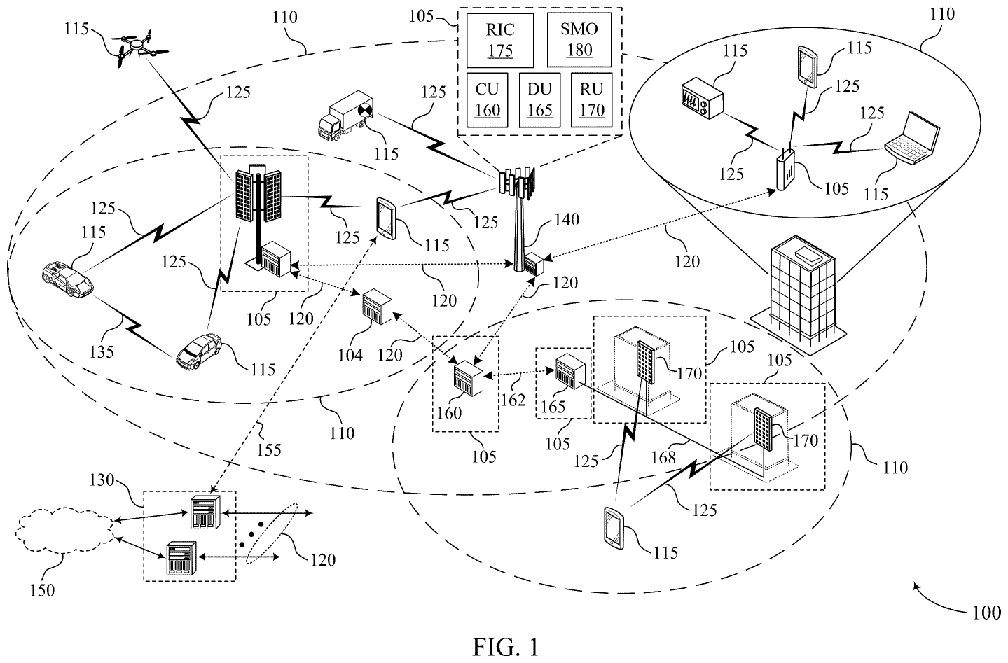

FIG. 1 shows an example of a wireless communications system 100 that supports a virtual fluid demodulation reference signal pattern for data transmissions in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support a virtual fluid demodulation reference signal pattern for data transmissions as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

According to the techniques described herein, a network entity may indicate a DMRS pattern starting from a first SLIV of a long data burst, a starting offset, and a symbol spacing between consecutive DMRS symbols. The network entity may signal these parameters via RRC signaling. The network entity may then send a first DCI to indicate a start of the DMRS pattern and a last DCI to indicate the end of the DMRS pattern.

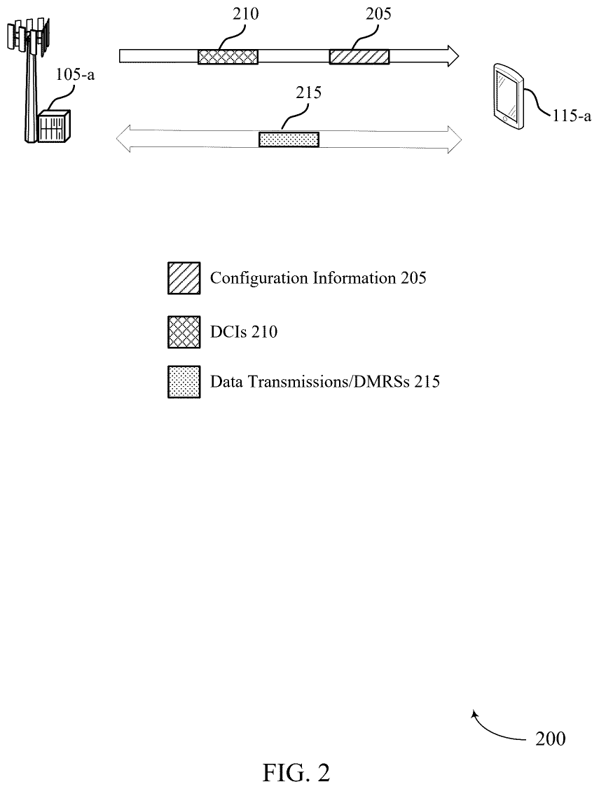

FIG. 2 shows an example of a wireless communications system 200 that supports a virtual fluid demodulation reference signal pattern for data transmissions in accordance with one or more aspects of the present disclosure. Wireless communications system 200 may implement or may be implemented by aspects of the wireless communications system 100. For example, wireless communications system 200 may include a UE 115-a, which may be an example of a UE 115 as described herein. Wireless communications system 200 may include a network entity 105-a, which may be an example of a network entity 105 as described herein.

In some examples of wireless communications system 200, network entity 105-a and UE 115-a may utilize DMRSs. For instance, DMRSs may be reference signals embedded within a shared channel, such as data transmissions 215. A shared channel may be, for example, a physical uplink shared channel (PUSCH) or a physical downlink shared channel (PDSCH). As used herein, PxSCH refers to a physical shared channel of any direction, and thus one example of a PxSCH is a PUSCH and another example of PxSCH is a PDSCH. As such, network entity 105-a and UE 115-a may utilize DMRSs in conjunction with data transmissions 215, where the UE 115-a may leverage symbols to estimate channel conditions for the corresponding data symbols, which may increase accuracy associated with data transmissions 215.

In some examples, network entity 105-a may transmit configuration information 205 to UE 115-a. Configuration information 205 may identify a DMRS pattern, where the DMRS pattern includes a starting symbol offset of a first DMRS in the DMRS pattern, a quantity of symbols between each DMRS in the DMRS pattern, and a last symbol offset of a last DMRS in the DMRS pattern. Configuration information 205 may include a plurality of DMRS patterns where each of the DMRS patterns may be associated with respective starting symbol offsets, quantities of symbols between each DMRS, and last symbol offsets. In some examples, configuration information 205 may be transmitted via a radio resource control message.

In some examples, network entity 105-a may transmit DCIs 210 to UE 115-a. DCIs 210 may include a plurality of DCIs, where a first DCI of DCIs 210 may indicate a first SLIV for a first data transmission. The first DCI of DCIs 210 may indicate a DMRS pattern of the plurality of DMRS patterns identified within configuration information 205 that the UE will use. DCIs 210 may also include a last DCI which indicates a last SLIV for a last data transmission that is scheduled to occur after the first data transmission. There may be any number of DCIs transmitted between the first DCI and the last DCI of DCIs 210.

In some examples, network entity 105-a may transmit data transmissions and DMRSs to UE 115-a. Data transmissions 215 may include a plurality of slots, and network entity 105-a may transmit a plurality of DMRSs over the plurality of slots in accordance with a DMRS pattern. The plurality of DMRSs may include the first and last DMRSs detailed above, including any number of DMRSs transmitted between the first DMRS and the last DMRS. In some examples, the first DMRS is received in accordance with the starting symbol offset with respect to the first SLIV, and the last DMRS is received in accordance with the last symbol offset with respect to the last SLIV.

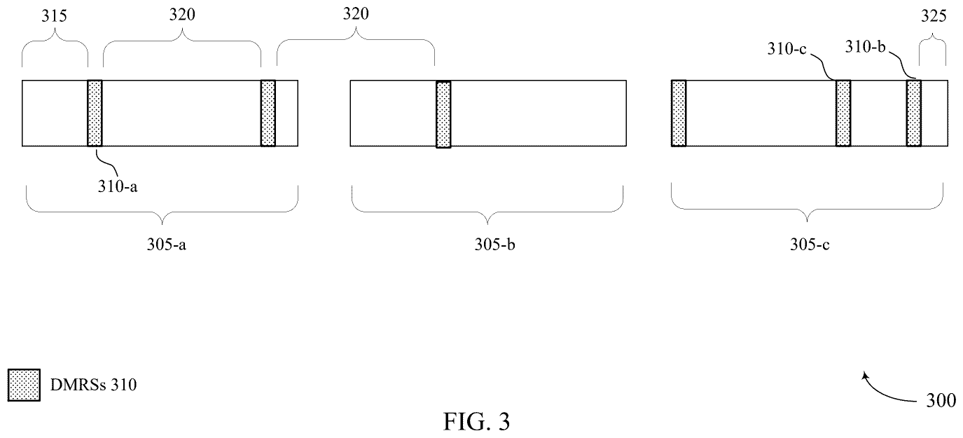

FIG. 3 shows an example of a slot diagram 300 that supports a virtual fluid demodulation reference signal pattern for data transmissions in accordance with one or more aspects of the present disclosure. Slot diagram 300 may illustrate PxSCH data transmissions between a network entity 105 and a UE 115. Slot diagram 300 may include slots 305, where slots 305 may include DMRSs 310. DMRSs 310 may be spaced throughout slots 305 in accordance with starting symbol offset 315, spacing 320, and last symbol offset 325. Although slot diagram 300 is illustrated with three slots, slots 305-a, 305-b, and 305-c, there may be any quantity of slots and the quantity of slots may be undetermined at the beginning of a PxSCH data burst.

A UE 115 may receive a first DCI which may indicate a DMRS pattern that UE 115 may utilize from a plurality of DMRS patterns. In some examples, if a plurality of DMRS patterns are configured via RRC signaling, the DMRS patterns may be indexed and the first DCI may include a pattern index to select a DMRS pattern. In some examples, the first DCI may include one or more fields indicating a beginning of the first PxSCH transmission and an activation of the DMRS pattern.

Slot diagram 300 may illustrate a DMRS pattern where a first DMRS 310-a may be located by a quantity of symbols from a first symbol of slot 305-a indicated by starting symbol offset 315. The first symbol may be indicated by a first SLIV and in some examples, the first SLIV may be shorter or extend beyond slot 305-a. In some examples, the first SLIV may indicate a length that spans a plurality of slots 305. Spacing 320 may be indicated by the DMRS pattern and may represent a quantity of symbols between consecutive DMRSs 310.

A UE 115 may receive a last DCI of a plurality of DCIs which may indicate a last SLIV of a PxSCH burst. A last DMRS 310-b of the last SLIV may be located by a quantity of symbols from a last symbol of slot 305-c represented by last symbol offset 325. In some examples, a second to last DMRS 310-c (immediately preceding last DMRS 310-b) may be separated from last DMRS 310-b by a quantity of symbols which is less than the quantity of symbols associated with spacing 320.

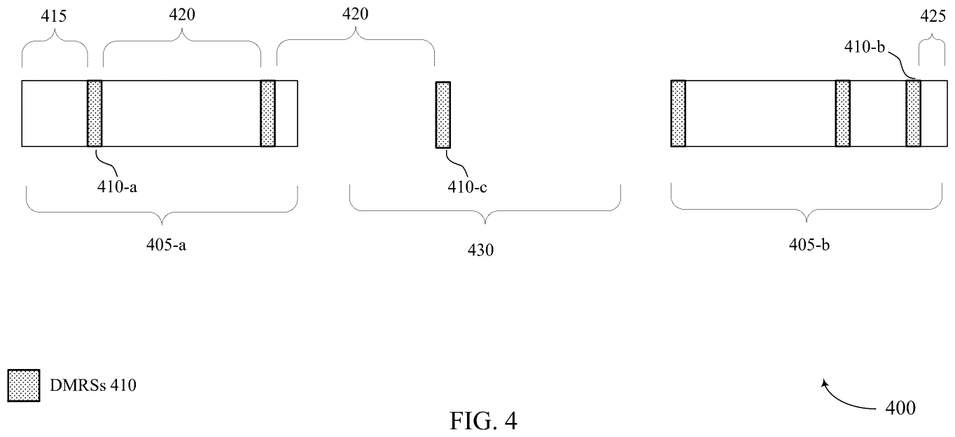

FIG. 4 shows an example of a slot diagram 400 that supports a virtual fluid demodulation reference signal pattern for data transmissions in accordance with one or more aspects of the present disclosure. Slot diagram 400 may illustrate PxSCH data transmissions between a network entity 105 and a UE 115. Slot diagram 400 may include slots 405, where slots 405 may include DMRSs 410. DMRSs 410 may be spaced throughout slots 405 in accordance with starting symbol offset 415, spacing 420, and last symbol offset 425. Although slot diagram 400 is illustrated with two slots, slots 405-a and 405-b, there may be any quantity of slots and the quantity of slots may be undetermined at the beginning of a PxSCH data burst.

Slot diagram 400 may illustrate a DMRS pattern indicated by a first DCI where a first DMRS 410-a may be located by a quantity of symbols from a first symbol of slot 405-a indicated by starting symbol offset 415. Spacing 420 may be indicated by the DMRS pattern and may represent a quantity of symbols between consecutive DMRSs 410. A UE 115 may receive a last DCI of a plurality of DCIs which may indicate a last SLIV of a PxSCH burst. A last DMRS 410-b of the last SLIV may be located by a quantity of symbols from a last symbol of slot 405-b represented by last symbol offset 425.

Slot diagram 400 may illustrate an example where in the middle of a PxSCH burst, there could be a gap 430 between slot 405-a and slot 405-b when a packet arrives late. In some examples, an orphan DMRS 410-c may be transmitted according to the indicated DMRS pattern during gap 430.

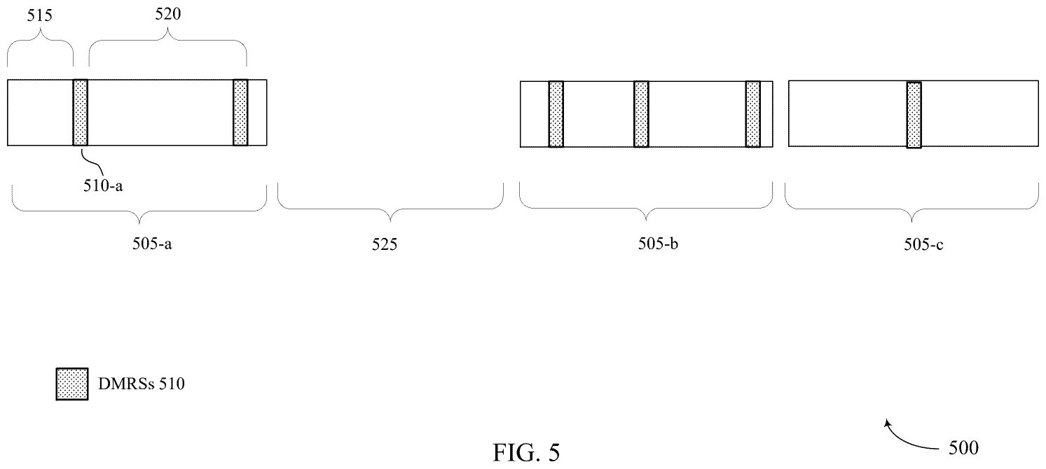

FIG. 5 shows an example of a slot diagram 500 that supports a virtual fluid demodulation reference signal pattern for data transmissions in accordance with one or more aspects of the present disclosure. Slot diagram 500 may illustrate PxSCH data transmissions between a network entity 105 and a UE 115. Slot diagram 500 may include slots 505, where slots 505 may include DMRSs 510. DMRSs 510 may be spaced throughout slots 505 in accordance with starting symbol offset 515 and spacing 520. Although slot diagram 500 is illustrated with three slots, slots 505-a, 505-b, and 505-c, there may be any quantity of slots and the quantity of slots may be undetermined at the beginning of a PxSCH data burst.

Slot diagram 500 may illustrate a DMRS pattern indicated by a first DCI where a first DMRS 510-a may be located by a quantity of symbols from a first symbol of slot 505-a indicated by starting symbol offset 515. Spacing 520 may be indicated by the DMRS pattern and may represent a quantity of symbols between consecutive DMRSs 510. In another example where a gap 525 occurs between slot 505-a and slot 505-b, an orphan DMRS may not be transmitted according to the indicated (i.e., first) DMRS pattern. Instead, a second DMRS pattern may be preconfigured via RRC messaging, where the second DMRS pattern includes a more dense distribution of DMRSs that is transmitted in a SLIV immediately after gap 525 than in the first DMRS pattern. Slot 505-b may represent a denser DMRS distribution in a slot as compared to slot 505-a. A network entity may preconfigure the denser DMRS distribution to ensure that a receiver has enough DMRS symbols for decoding. The denser DMRS distribution may be configured by default after a gap or a network entity may transmit a DCI that indicates the denser DMRS distribution.

In an example, in a SLIV immediately following slot 505-b, DMRSs may be transmitted in slot 505-c in accordance with the first DMRS pattern.

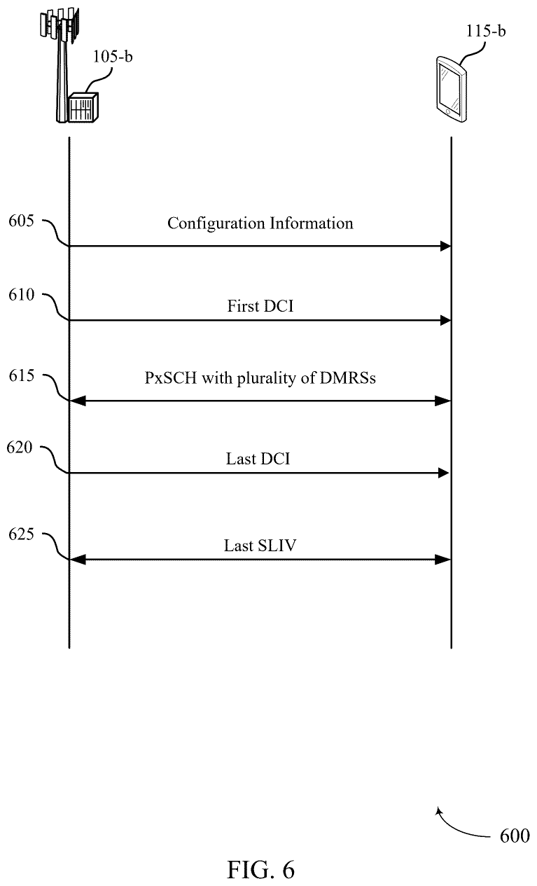

FIG. 6 shows an example of a process flow diagram 600 that supports a virtual fluid demodulation reference signal pattern for data transmissions in accordance with one or more aspects of the present disclosure. In some examples, process flow diagram 600 may implement or be implemented by aspects of wireless communications system 100 as described with reference to FIG. 1, or by wireless communications system 200 as described with reference to FIG. 2. For example, process flow diagram 600 may be implemented by a network entity 105-b, which may be an example of the network entities 105 as described with reference to FIGS. 1 and 2. Process flow diagram 600 may be implemented by UE 115-b, which may be an example of the UEs as described with reference to FIGS. 1 and 2.

At 605, network entity 105-b may transmit, and UE 115-b may receive, configuration information. The configuration information may identify a DMRS pattern, where the DMRS pattern includes a starting symbol offset of a first DMRS in the DMRS pattern, a quantity of symbols between each DMRS in the DMRS pattern, and a last symbol offset of a last DMRS in the DMRS pattern. The configuration information may include a plurality of DMRS patterns where each of the DMRS patterns may be associated with respective starting symbol offsets, quantities of symbols between each DMRS, and last symbol offsets. In some examples, the configuration information may be transmitted via a radio resource control message.

At 610, network entity 105-b may transmit, and UE 115-b may receive, a first DCI of a plurality of DCIs which may indicate a first SLIV for a first data transmission. The first DCI may indicate a DMRS pattern of the plurality of DMRS patterns identified within the configuration information that the UE will use.

At 615, network entity 105-b and UE 115-b may exchange PxSCH communications, which may include a plurality of DMRSs. The plurality of DMRSs may include first and last DMRSs, including any number of DMRSs transmitted between the first DMRS and the last DMRS. In some examples, the first DMRS is received in accordance with the starting symbol offset with respect to the first SLIV.

At 620, network entity 105-b may transmit, and UE 115-b may receive, a last DCI of a plurality of DCIs which may indicate a last SLIV for a last data transmission.

At 625, network entity 105-b and UE 115-b may exchange PxSCH communications including the last SLIV identified by the last DCI at 620. In some examples, the last DMRS is received in accordance with the last symbol offset with respect to the last SLIV. In some examples, an additional DMRS may be transmitted after the last DMRS based on the last DMRS being greater than a threshold quantity of symbols away from a last symbol indicated by the last SLIV. In some examples, the additional DMRS after the last DMRS and the symbol location of the additional DMRS may be indicated by a DCI.

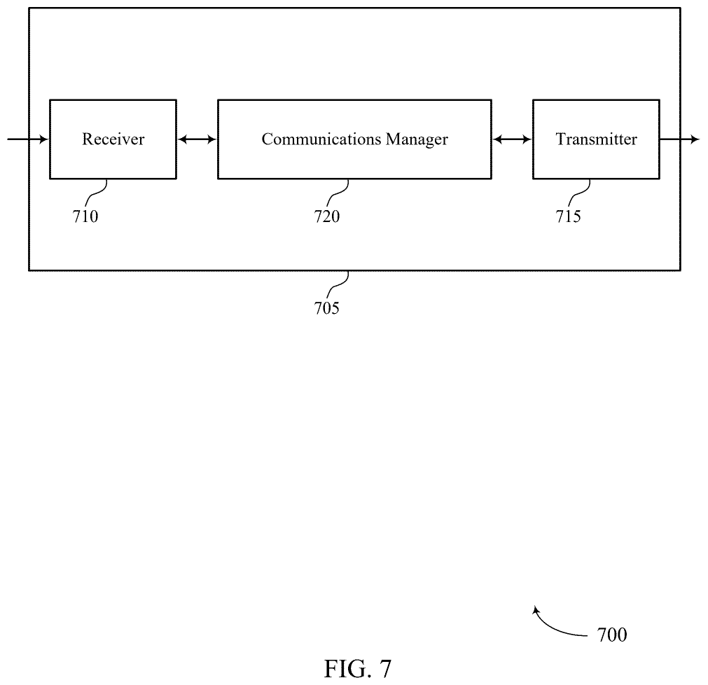

FIG. 7 shows a block diagram 700 of a device 705 that supports a virtual fluid demodulation reference signal pattern for data transmissions in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to a virtual fluid demodulation reference signal pattern for data transmissions). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to a virtual fluid demodulation reference signal pattern for data transmissions). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of a virtual fluid demodulation reference signal pattern for data transmissions as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving configuration information that identifies a DMRS pattern, the DMRS pattern associated with a starting symbol offset of a first DMRS in the DMRS pattern, a quantity of symbols between each DMRS in the DMRS pattern, and a last symbol offset of a last DMRS in the DMRS pattern. The communications manager 720 is capable of, configured to, or operable to support a means for receiving a first DCI that indicates a first start and length indicator value (SLIV) for a first data transmission. The communications manager 720 is capable of, configured to, or operable to support a means for receiving a last DCI that indicates a last SLIV for a last data transmission that is scheduled to occur after the first data transmission. The communications manager 720 is capable of, configured to, or operable to support a means for receiving a set of multiple DMRSs over a set of multiple slots in accordance with the DMRS pattern, the set of multiple DMRSs including the first DMRS, the last DMRS, and one or more additional DMRSs received after the first DMRS and before the last DMRS, where the first DMRS is received in accordance with the starting symbol offset with respect to the first SLIV, and where the last DMRS is received in accordance with the last symbol offset with respect to the last SLIV.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for a virtual fluid demodulation reference signal pattern for data transmissions which may result in lower system overhead and lower latency.

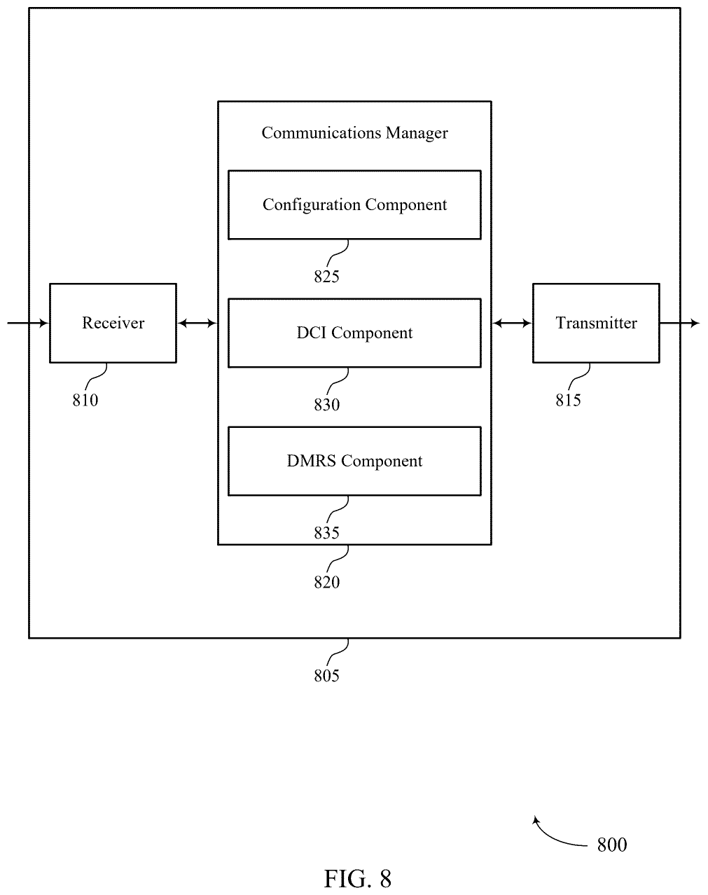

FIG. 8 shows a block diagram 800 of a device 805 that supports a virtual fluid demodulation reference signal pattern for data transmissions in accordance with one or more aspects of the present disclosure. The device 805 may be an example of aspects of a device 705 or a UE 115 as described herein. The device 805 may include a receiver 810, a transmitter 815, and a communications manager 820. The device 805, or one of more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to a virtual fluid demodulation reference signal pattern for data transmissions). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to a virtual fluid demodulation reference signal pattern for data transmissions). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of a virtual fluid demodulation reference signal pattern for data transmissions as described herein. For example, the communications manager 820 may include a Configuration component 825, a DCI component 830, a DMRS component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The Configuration component 825 is capable of, configured to, or operable to support a means for receiving configuration information that identifies a DMRS pattern, the DMRS pattern associated with a starting symbol offset of a first DMRS in the DMRS pattern, a quantity of symbols between each DMRS in the DMRS pattern, and a last symbol offset of a last DMRS in the DMRS pattern. The DCI component 830 is capable of, configured to, or operable to support a means for receiving a first DCI that indicates a first start and length indicator value (SLIV) for a first data transmission. The DCI component 830 is capable of, configured to, or operable to support a means for receiving a last DCI that indicates a last SLIV for a last data transmission that is scheduled to occur after the first data transmission. The DMRS component 835 is capable of, configured to, or operable to support a means for receiving a set of multiple DMRSs over a set of multiple slots in accordance with the DMRS pattern, the set of multiple DMRSs including the first DMRS, the last DMRS, and one or more additional DMRSs received after the first DMRS and before the last DMRS, where the first DMRS is received in accordance with the starting symbol offset with respect to the first SLIV, and where the last DMRS is received in accordance with the last symbol offset with respect to the last SLIV.

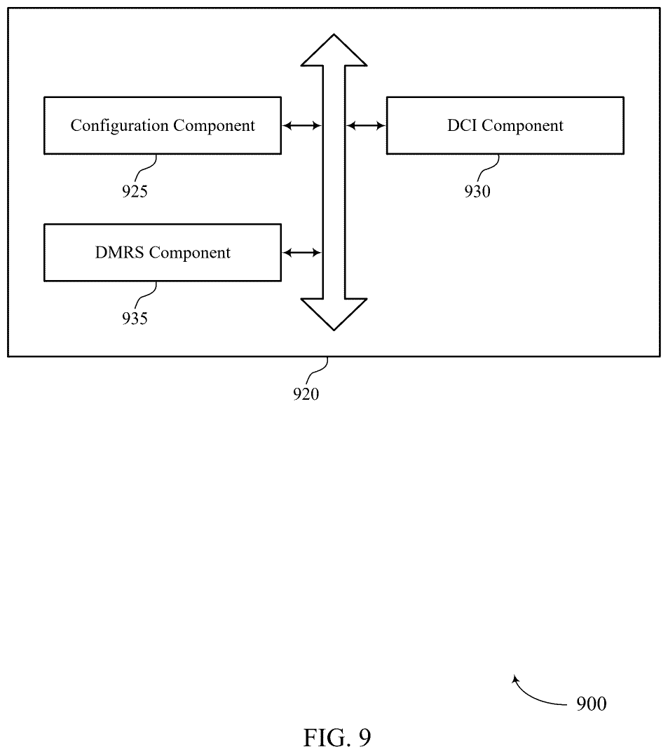

FIG. 9 shows a block diagram 900 of a communications manager 920 that supports a virtual fluid demodulation reference signal pattern for data transmissions in accordance with one or more aspects of the present disclosure. The communications manager 920 may be an example of aspects of a communications manager 720, a communications manager 820, or both, as described herein. The communications manager 920, or various components thereof, may be an example of means for performing various aspects of a virtual fluid demodulation reference signal pattern for data transmissions as described herein. For example, the communications manager 920 may include a Configuration component 925, a DCI component 930, a DMRS component 935, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The Configuration component 925 is capable of, configured to, or operable to support a means for receiving configuration information that identifies a DMRS pattern, the DMRS pattern associated with a starting symbol offset of a first DMRS in the DMRS pattern, a quantity of symbols between each DMRS in the DMRS pattern, and a last symbol offset of a last DMRS in the DMRS pattern. The DCI component 930 is capable of, configured to, or operable to support a means for receiving a first DCI that indicates a first start and length indicator value (SLIV) for a first data transmission. In some examples, the DCI component 930 is capable of, configured to, or operable to support a means for receiving a last DCI that indicates a last SLIV for a last data transmission that is scheduled to occur after the first data transmission. The DMRS component 935 is capable of, configured to, or operable to support a means for receiving a set of multiple DMRSs over a set of multiple slots in accordance with the DMRS pattern, the set of multiple DMRSs including the first DMRS, the last DMRS, and one or more additional DMRSs received after the first DMRS and before the last DMRS, where the first DMRS is received in accordance with the starting symbol offset with respect to the first SLIV, and where the last DMRS is received in accordance with the last symbol offset with respect to the last SLIV.

In some examples, the configuration information includes a set of multiple DMRS patterns, each of the DMRS patterns of the set of multiple DMRS patterns associated with respective starting symbol offsets, quantities of symbols between each DMRS, and last symbol offsets. In some examples, the first DCI indicates the DMRS pattern of the set of multiple DMRS patterns the UE is to use.

In some examples, the first DMRS is offset in accordance with the starting symbol offset with respect to a beginning symbol indicated by the first SLIV.

In some examples, the last DMRS is offset in accordance with the last symbol offset with respect to a last symbol indicated by the last SLIV.

In some examples, a second to last DMRS preceding the last DMRS is separated by less than the quantity of symbols indicated by the configuration information between each DMRS in the DMRS pattern.

In some examples, the first DCI includes one or more fields indicating a beginning of the first data transmission and an activation of the DMRS pattern.

In some examples, the first data transmission and the last data transmission are part of a data transmission burst. In some examples, a gap of one or more slots exists in the data transmission burst.

In some examples, the DMRS component 935 is capable of, configured to, or operable to support a means for receiving an orphan DMRS in accordance with the DMRS pattern during the gap.

In some examples, the DMRS pattern is a first DMRS pattern, and the DMRS component 935 is capable of, configured to, or operable to support a means for receiving one or more DMRSs in accordance with the second DMRS pattern during one or more slots indicated by a second SLIV immediately after the gap.

In some examples, the DCI component 930 is capable of, configured to, or operable to support a means for receiving a third DCI including one or more fields indicating an activation of the second DMRS pattern.

In some examples, the DMRS component 935 is capable of, configured to, or operable to support a means for receiving a DMRS after the last DMRS based on the last DMRS being greater than a threshold quantity of symbols away from a last symbol indicated by the last SLIV.

In some examples, the DCI component 930 is capable of, configured to, or operable to support a means for receiving a third DCI indicating the DMRS after the last DMRS, where a symbol position of the DMRS is indicated by the DCI.

In some examples, the first SLIV indicates a length that spans a set of multiple slots.

In some examples, the configuration information is a radio resource control message.

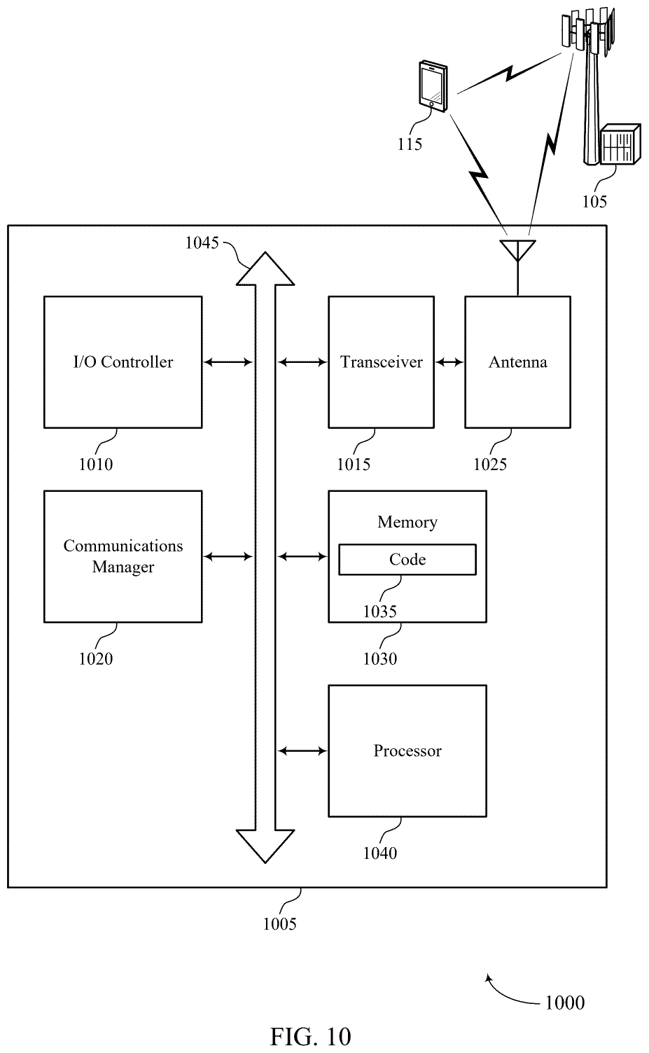

FIG. 10 shows a diagram of a system 1000 including a device 1005 that supports a virtual fluid demodulation reference signal pattern for data transmissions in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting a virtual fluid demodulation reference signal pattern for data transmissions). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving configuration information that identifies a DMRS pattern, the DMRS pattern associated with a starting symbol offset of a first DMRS in the DMRS pattern, a quantity of symbols between each DMRS in the DMRS pattern, and a last symbol offset of a last DMRS in the DMRS pattern. The communications manager 1020 is capable of, configured to, or operable to support a means for receiving a first DCI that indicates a first start and length indicator value (SLIV) for a first data transmission. The communications manager 1020 is capable of, configured to, or operable to support a means for receiving a last DCI that indicates a last SLIV for a last data transmission that is scheduled to occur after the first data transmission. The communications manager 1020 is capable of, configured to, or operable to support a means for receiving a set of multiple DMRSs over a set of multiple slots in accordance with the DMRS pattern, the set of multiple DMRSs including the first DMRS, the last DMRS, and one or more additional DMRSs received after the first DMRS and before the last DMRS, where the first DMRS is received in accordance with the starting symbol offset with respect to the first SLIV, and where the last DMRS is received in accordance with the last symbol offset with respect to the last SLIV.

By including or configuring the communications manager 1020 in accordance with examples as described herein, the device 1005 may support techniques for a virtual fluid demodulation reference signal pattern for data transmissions which may result in lower system overhead and lower latency.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of a virtual fluid demodulation reference signal pattern for data transmissions as described herein, or the at least one processor 1040 and the at least one memory 1030 may be otherwise configured to, individually or collectively, perform or support such operations.

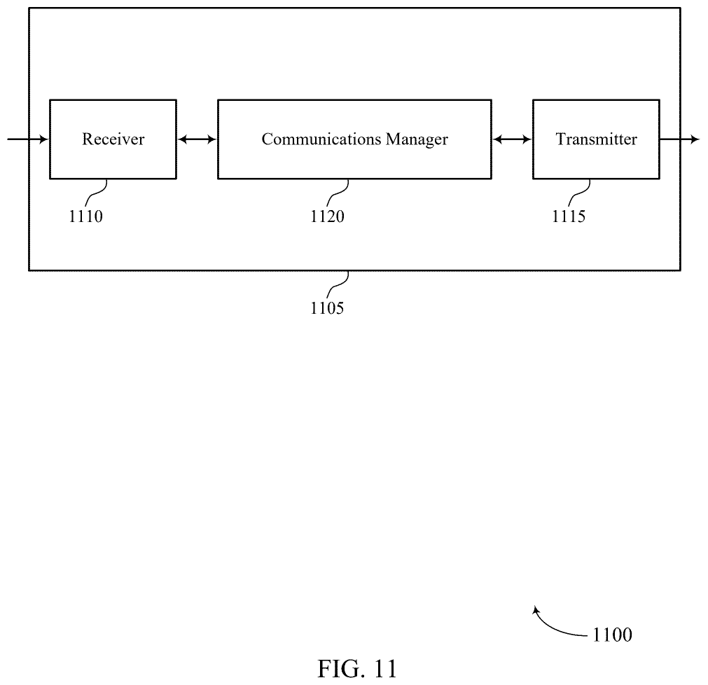

FIG. 11 shows a block diagram 1100 of a device 1105 that supports a virtual fluid demodulation reference signal pattern for data transmissions in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of a virtual fluid demodulation reference signal pattern for data transmissions as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for transmitting configuration information that identifies a DMRS pattern, the DMRS pattern associated with a starting symbol offset of a first DMRS in the DMRS pattern, a quantity of symbols between each DMRS in the DMRS pattern, and a last symbol offset of a last DMRS in the DMRS pattern. The communications manager 1120 is capable of, configured to, or operable to support a means for transmitting a first DCI that indicates a first start and length indicator value (SLIV) for a first data transmission. The communications manager 1120 is capable of, configured to, or operable to support a means for transmitting a last DCI that indicates a last SLIV for a last data transmission that is scheduled to occur after the first data transmission. The communications manager 1120 is capable of, configured to, or operable to support a means for transmitting a set of multiple DMRSs over a set of multiple slots in accordance with the DMRS pattern, the set of multiple DMRSs including the first DMRS, the last DMRS, and one or more additional DMRSs received after the first DMRS and before the last DMRS, where the first DMRS is received in accordance with the starting symbol offset with respect to the first SLIV, and where the last DMRS is transmitted in accordance with the last symbol offset with respect to the last SLIV.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for a virtual fluid demodulation reference signal pattern for data transmissions which may result in lower system overhead and lower latency.

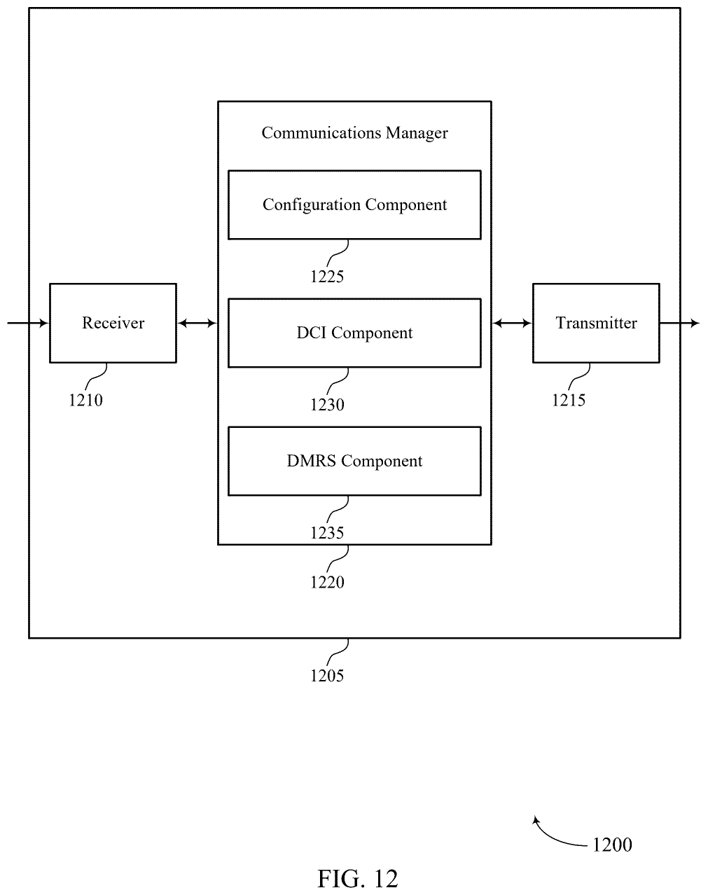

FIG. 12 shows a block diagram 1200 of a device 1205 that supports a virtual fluid demodulation reference signal pattern for data transmissions in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one of more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of a virtual fluid demodulation reference signal pattern for data transmissions as described herein. For example, the communications manager 1220 may include a configuration component 1225, a DCI component 1230, a DMRS component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The configuration component 1225 is capable of, configured to, or operable to support a means for transmitting configuration information that identifies a DMRS pattern, the DMRS pattern associated with a starting symbol offset of a first DMRS in the DMRS pattern, a quantity of symbols between each DMRS in the DMRS pattern, and a last symbol offset of a last DMRS in the DMRS pattern. The DCI component 1230 is capable of, configured to, or operable to support a means for transmitting a first DCI that indicates a first start and length indicator value (SLIV) for a first data transmission. The DCI component 1230 is capable of, configured to, or operable to support a means for transmitting a last DCI that indicates a last SLIV for a last data transmission that is scheduled to occur after the first data transmission. The DMRS component 1235 is capable of, configured to, or operable to support a means for transmitting a set of multiple DMRSs over a set of multiple slots in accordance with the DMRS pattern, the set of multiple DMRSs including the first DMRS, the last DMRS, and one or more additional DMRSs received after the first DMRS and before the last DMRS, where the first DMRS is received in accordance with the starting symbol offset with respect to the first SLIV, and where the last DMRS is transmitted in accordance with the last symbol offset with respect to the last SLIV.

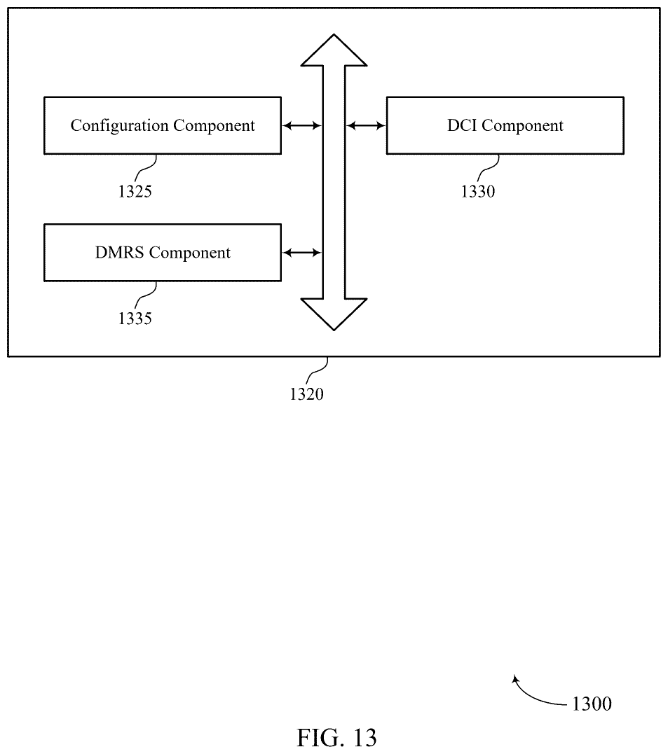

FIG. 13 shows a block diagram 1300 of a communications manager 1320 that supports a virtual fluid demodulation reference signal pattern for data transmissions in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of a virtual fluid demodulation reference signal pattern for data transmissions as described herein. For example, the communications manager 1320 may include a configuration component 1325, a DCI component 1330, a DMRS component 1335, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The configuration component 1325 is capable of, configured to, or operable to support a means for transmitting configuration information that identifies a DMRS pattern, the DMRS pattern associated with a starting symbol offset of a first DMRS in the DMRS pattern, a quantity of symbols between each DMRS in the DMRS pattern, and a last symbol offset of a last DMRS in the DMRS pattern. The DCI component 1330 is capable of, configured to, or operable to support a means for transmitting a first DCI that indicates a first start and length indicator value (SLIV) for a first data transmission. In some examples, the DCI component 1330 is capable of, configured to, or operable to support a means for transmitting a last DCI that indicates a last SLIV for a last data transmission that is scheduled to occur after the first data transmission. The DMRS component 1335 is capable of, configured to, or operable to support a means for transmitting a set of multiple DMRSs over a set of multiple slots in accordance with the DMRS pattern, the set of multiple DMRSs including the first DMRS, the last DMRS, and one or more additional DMRSs received after the first DMRS and before the last DMRS, where the first DMRS is received in accordance with the starting symbol offset with respect to the first SLIV, and where the last DMRS is transmitted in accordance with the last symbol offset with respect to the last SLIV.

In some examples, the configuration information includes a set of multiple DMRS patterns, each of the DMRS patterns of the set of multiple DMRS patterns associated with respective starting symbol offsets, quantities of symbols between each DMRS, and last symbol offsets. In some examples, the first DCI indicates the DMRS pattern of the set of multiple DMRS patterns a user equipment is to use.

In some examples, the first DMRS is offset in accordance with the starting symbol offset with respect to a beginning symbol indicated by the first SLIV.

In some examples, the last DMRS is offset in accordance with the last symbol offset with respect to a last symbol indicated by the last SLIV.

In some examples, a second to last DMRS preceding the last DMRS is separated by less than the quantity of symbols indicated by the configuration information between each DMRS in the DMRS pattern.

In some examples, the first DCI includes one or more fields indicating a beginning of the first data transmission and an activation of the DMRS pattern.

In some examples, the first data transmission and the last data transmission are part of a data transmission burst. In some examples, a gap of one or more slots exists in the data transmission burst.

In some examples, the DMRS component 1335 is capable of, configured to, or operable to support a means for transmitting an orphan DMRS in accordance with the DMRS pattern during the gap.

In some examples, the DMRS pattern is a first DMRS pattern, and the DMRS component 1335 is capable of, configured to, or operable to support a means for transmitting one or more DMRSs in accordance with the second DMRS pattern during one or more slots indicated by a second SLIV immediately after the gap.

In some examples, the DCI component 1330 is capable of, configured to, or operable to support a means for transmitting a third DCI including one or more fields indicating an activation of the second DMRS pattern.

In some examples, the DMRS component 1335 is capable of, configured to, or operable to support a means for transmitting a DMRS after the last DMRS based on the last DMRS being greater than a threshold quantity of symbols away from a last symbol indicated by the last SLIV.

In some examples, the DCI component 1330 is capable of, configured to, or operable to support a means for transmitting a third DCI indicating the DMRS after the last DMRS, where a symbol position of the DMRS is indicated by the DCI.

In some examples, the first SLIV indicates a length that spans a set of multiple slots.

In some examples, the configuration information is a radio resource control message.

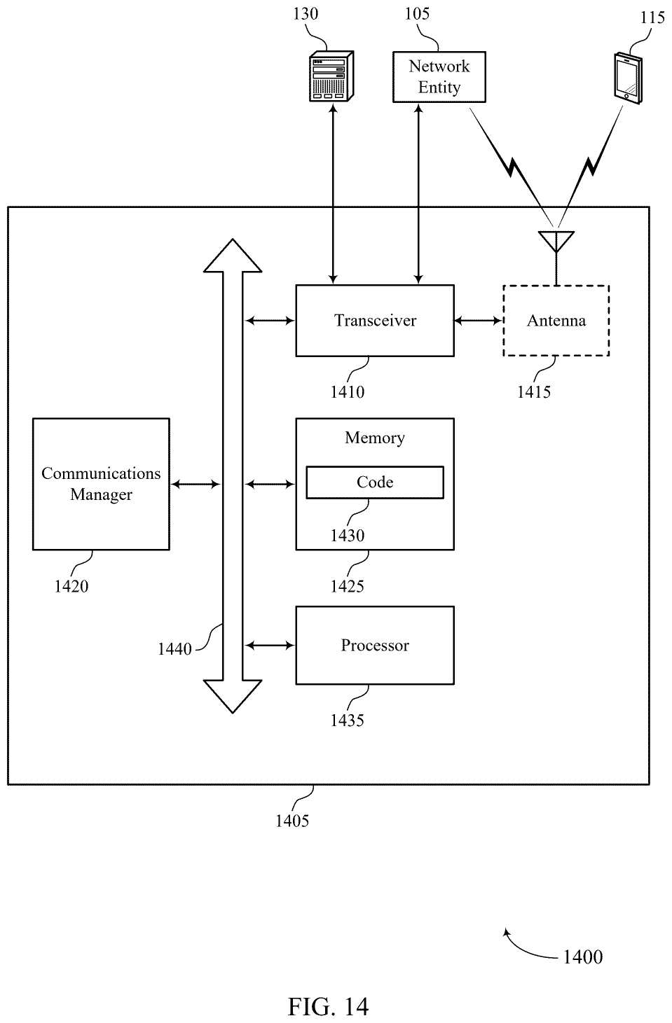

FIG. 14 shows a diagram of a system 1400 including a device 1405 that supports a virtual fluid demodulation reference signal pattern for data transmissions in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting a virtual fluid demodulation reference signal pattern for data transmissions). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for transmitting configuration information that identifies a DMRS pattern, the DMRS pattern associated with a starting symbol offset of a first DMRS in the DMRS pattern, a quantity of symbols between each DMRS in the DMRS pattern, and a last symbol offset of a last DMRS in the DMRS pattern. The communications manager 1420 is capable of, configured to, or operable to support a means for transmitting a first DCI that indicates a first start and length indicator value (SLIV) for a first data transmission. The communications manager 1420 is capable of, configured to, or operable to support a means for transmitting a last DCI that indicates a last SLIV for a last data transmission that is scheduled to occur after the first data transmission. The communications manager 1420 is capable of, configured to, or operable to support a means for transmitting a set of multiple DMRSs over a set of multiple slots in accordance with the DMRS pattern, the set of multiple DMRSs including the first DMRS, the last DMRS, and one or more additional DMRSs received after the first DMRS and before the last DMRS, where the first DMRS is received in accordance with the starting symbol offset with respect to the first SLIV, and where the last DMRS is transmitted in accordance with the last symbol offset with respect to the last SLIV.

By including or configuring the communications manager 1420 in accordance with examples as described herein, the device 1405 may support techniques for a virtual fluid demodulation reference signal pattern for data transmissions which may result in lower system overhead and lower latency.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of a virtual fluid demodulation reference signal pattern for data transmissions as described herein, or the at least one processor 1435 and the at least one memory 1425 may be otherwise configured to, individually or collectively, perform or support such operations.

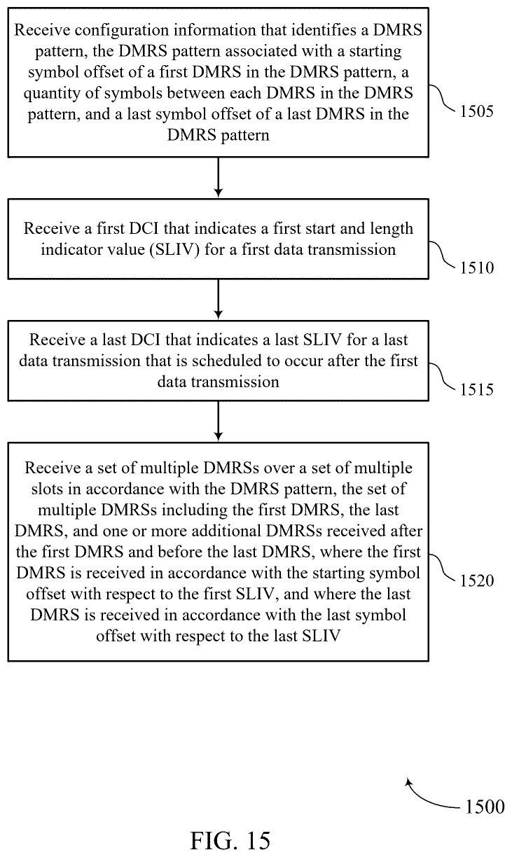

FIG. 15 shows a flowchart illustrating a method 1500 that supports a virtual fluid demodulation reference signal pattern for data transmissions in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving configuration information that identifies a DMRS pattern, the DMRS pattern associated with a starting symbol offset of a first DMRS in the DMRS pattern, a quantity of symbols between each DMRS in the DMRS pattern, and a last symbol offset of a last DMRS in the DMRS pattern. The operations of 1505 may be performed in accordance with examples as disclosed herein. In some examples, aspects of the operations of 1505 may be performed by a Configuration component 925 as described with reference to FIG. 9.

At 1510, the method may include receiving a first DCI that indicates a first start and length indicator value (SLIV) for a first data transmission. The operations of 1510 may be performed in accordance with examples as disclosed herein. In some examples, aspects of the operations of 1510 may be performed by a DCI component 930 as described with reference to FIG. 9.

At 1515, the method may include receiving a last DCI that indicates a last SLIV for a last data transmission that is scheduled to occur after the first data transmission. The operations of 1515 may be performed in accordance with examples as disclosed herein. In some examples, aspects of the operations of 1515 may be performed by a DCI component 930 as described with reference to FIG. 9.

At 1520, the method may include receiving a set of multiple DMRSs over a set of multiple slots in accordance with the DMRS pattern, the set of multiple DMRSs including the first DMRS, the last DMRS, and one or more additional DMRSs received after the first DMRS and before the last DMRS, where the first DMRS is received in accordance with the starting symbol offset with respect to the first SLIV, and where the last DMRS is received in accordance with the last symbol offset with respect to the last SLIV. The operations of 1520 may be performed in accordance with examples as disclosed herein. In some examples, aspects of the operations of 1520 may be performed by a DMRS component 935 as described with reference to FIG. 9.

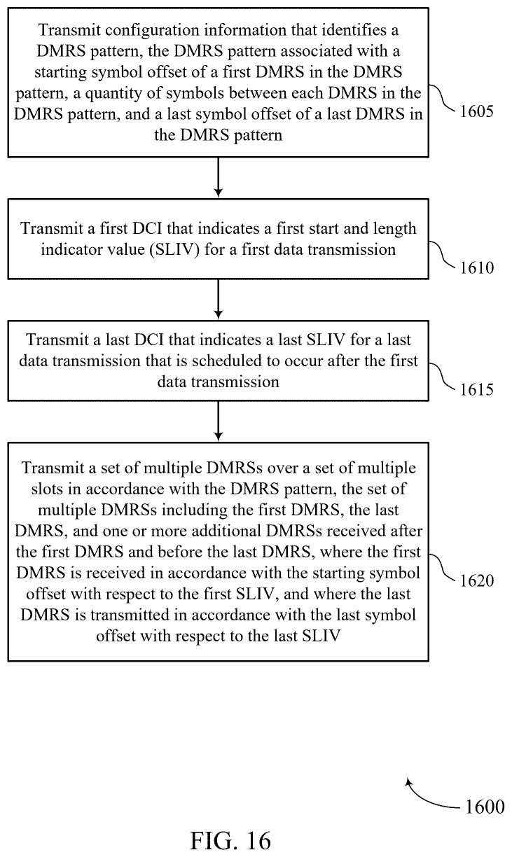

FIG. 16 shows a flowchart illustrating a method 1600 that supports a virtual fluid demodulation reference signal pattern for data transmissions in accordance with one or more aspects of the present disclosure. The operations of the method 1600 may be implemented by a network entity or its components as described herein. For example, the operations of the method 1600 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include transmitting configuration information that identifies a DMRS pattern, the DMRS pattern associated with a starting symbol offset of a first DMRS in the DMRS pattern, a quantity of symbols between each DMRS in the DMRS pattern, and a last symbol offset of a last DMRS in the DMRS pattern. The operations of 1605 may be performed in accordance with examples as disclosed herein. In some examples, aspects of the operations of 1605 may be performed by a configuration component 1325 as described with reference to FIG. 13.

At 1610, the method may include transmitting a first DCI that indicates a first start and length indicator value (SLIV) for a first data transmission. The operations of 1610 may be performed in accordance with examples as disclosed herein. In some examples, aspects of the operations of 1610 may be performed by a DCI component 1330 as described with reference to FIG. 13.

At 1615, the method may include transmitting a last DCI that indicates a last SLIV for a last data transmission that is scheduled to occur after the first data transmission. The operations of 1615 may be performed in accordance with examples as disclosed herein. In some examples, aspects of the operations of 1615 may be performed by a DCI component 1330 as described with reference to FIG. 13.

At 1620, the method may include transmitting a set of multiple DMRSs over a set of multiple slots in accordance with the DMRS pattern, the set of multiple DMRSs including the first DMRS, the last DMRS, and one or more additional DMRSs received after the first DMRS and before the last DMRS, where the first DMRS is received in accordance with the starting symbol offset with respect to the first SLIV, and where the last DMRS is transmitted in accordance with the last symbol offset with respect to the last SLIV. The operations of 1620 may be performed in accordance with examples as disclosed herein. In some examples, aspects of the operations of 1620 may be performed by a DMRS component 1335 as described with reference to FIG. 13.

The following provides an overview of aspects of the present disclosure:

Aspect 1: A method for wireless communications at a UE, comprising: receiving configuration information that identifies a DMRS pattern, the DMRS pattern associated with a starting symbol offset of a first DMRS in the DMRS pattern, a quantity of symbols between each DMRS in the DMRS pattern, and a last symbol offset of a last DMRS in the DMRS pattern; receiving a first DCI that indicates a first start and length indicator value (SLIV) for a first data transmission; receiving a last DCI that indicates a last SLIV for a last data transmission that is scheduled to occur after the first data transmission; and receiving a plurality of DMRSs over a plurality of slots in accordance with the DMRS pattern, the plurality of DMRSs including the first DMRS, the last DMRS, and one or more additional DMRSs received after the first DMRS and before the last DMRS, wherein the first DMRS is received in accordance with the starting symbol offset with respect to the first SLIV, and wherein the last DMRS is received in accordance with the last symbol offset with respect to the last SLIV.

Aspect 2: The method of aspect 1, wherein the configuration information comprises a plurality of DMRS patterns, each of the DMRS patterns of the plurality of DMRS patterns associated with respective starting symbol offsets, quantities of symbols between each DMRS, and last symbol offsets, and the first DCI indicates the DMRS pattern of the plurality of DMRS patterns the UE is to use.

Aspect 3: The method of any of aspects 1 through 2, wherein the first DMRS is offset in accordance with the starting symbol offset with respect to a beginning symbol indicated by the first SLIV.

Aspect 4: The method of any of aspects 1 through 3, wherein the last DMRS is offset in accordance with the last symbol offset with respect to a last symbol indicated by the last SLIV.

Aspect 5: The method of aspect 4, wherein a second to last DMRS preceding the last DMRS is separated by less than the quantity of symbols indicated by the configuration information between each DMRS in the DMRS pattern.

Aspect 6: The method of any of aspects 1 through 5, wherein the first DCI comprises one or more fields indicating a beginning of the first data transmission and an activation of the DMRS pattern.

Aspect 7: The method of any of aspects 1 through 6, wherein the first data transmission and the last data transmission are part of a data transmission burst, and a gap of one or more slots exists in the data transmission burst.

Aspect 8: The method of aspect 7, further comprising: receiving an orphan DMRS in accordance with the DMRS pattern during the gap.

Aspect 9: The method of any of aspects 7 through 8, wherein the DMRS pattern is a first DMRS pattern, and wherein the configuration information comprises a second DMRS pattern that includes a more dense distribution of DMRSs than in the first DMRS pattern, the method further comprising: receiving one or more DMRSs in accordance with the second DMRS pattern during one or more slots indicated by a second SLIV immediately after the gap.

Aspect 10: The method of aspect 9, further comprising: receiving a third DCI comprising one or more fields indicating an activation of the second DMRS pattern.

Aspect 11: The method of any of aspects 1 through 10, further comprising: receiving a DMRS after the last DMRS based at least in part on the last DMRS being greater than a threshold quantity of symbols away from a last symbol indicated by the last SLIV.

Aspect 12: The method of aspect 11, further comprising: receiving a third DCI indicating the DMRS after the last DMRS, wherein a symbol position of the DMRS is indicated by the DCI.

Aspect 13: The method of any of aspects 1 through 12, wherein the first SLIV indicates a length that spans a plurality of slots.

Aspect 14: The method of any of aspects 1 through 13, wherein the configuration information is a radio resource control message.

Aspect 15: A method for wireless communications at a network entity, comprising: transmitting configuration information that identifies a DMRS pattern, the DMRS pattern associated with a starting symbol offset of a first DMRS in the DMRS pattern, a quantity of symbols between each DMRS in the DMRS pattern, and a last symbol offset of a last DMRS in the DMRS pattern; transmitting a first DCI that indicates a first start and length indicator value (SLIV) for a first data transmission; transmitting a last DCI that indicates a last SLIV for a last data transmission that is scheduled to occur after the first data transmission; and transmitting a plurality of DMRSs over a plurality of slots in accordance with the DMRS pattern, the plurality of DMRSs including the first DMRS, the last DMRS, and one or more additional DMRSs received after the first DMRS and before the last DMRS, wherein the first DMRS is received in accordance with the starting symbol offset with respect to the first SLIV, and wherein the last DMRS is transmitted in accordance with the last symbol offset with respect to the last SLIV.

Aspect 16: The method of aspect 15, wherein the configuration information comprises a plurality of DMRS patterns, each of the DMRS patterns of the plurality of DMRS patterns associated with respective starting symbol offsets, quantities of symbols between each DMRS, and last symbol offsets, and the first DCI indicates the DMRS pattern of the plurality of DMRS patterns a user equipment is to use.

Aspect 17: The method of any of aspects 15 through 16, wherein the first DMRS is offset in accordance with the starting symbol offset with respect to a beginning symbol indicated by the first SLIV.

Aspect 18: The method of any of aspects 15 through 17, wherein the last DMRS is offset in accordance with the last symbol offset with respect to a last symbol indicated by the last SLIV.

Aspect 19: The method of aspect 18, wherein a second to last DMRS preceding the last DMRS is separated by less than the quantity of symbols indicated by the configuration information between each DMRS in the DMRS pattern.

Aspect 20: The method of any of aspects 15 through 19, wherein the first DCI comprises one or more fields indicating a beginning of the first data transmission and an activation of the DMRS pattern.

Aspect 21: The method of any of aspects 15 through 20, wherein the first data transmission and the last data transmission are part of a data transmission burst, and a gap of one or more slots exists in the data transmission burst.

Aspect 22: The method of aspect 21, further comprising: transmitting an orphan DMRS in accordance with the DMRS pattern during the gap.

Aspect 23: The method of any of aspects 21 through 22, wherein the DMRS pattern is a first DMRS pattern, and wherein the configuration information comprises a second DMRS pattern that includes a more dense distribution of DMRSs than in the first DMRS pattern, the method further comprising: transmitting one or more DMRSs in accordance with the second DMRS pattern during one or more slots indicated by a second SLIV immediately after the gap.

Aspect 24: The method of aspect 23, further comprising: transmitting a third DCI comprising one or more fields indicating an activation of the second DMRS pattern.

Aspect 25: The method of any of aspects 15 through 24, further comprising: transmitting a DMRS after the last DMRS based at least in part on the last DMRS being greater than a threshold quantity of symbols away from a last symbol indicated by the last SLIV.

Aspect 26: The method of aspect 25, further comprising: transmitting a third DCI indicating the DMRS after the last DMRS, wherein a symbol position of the DMRS is indicated by the DCI.

Aspect 27: The method of any of aspects 15 through 26, wherein the first SLIV indicates a length that spans a plurality of slots.

Aspect 28: The method of any of aspects 15 through 27, wherein the configuration information is a radio resource control message.

Aspect 29: A UE for wireless communications, comprising one or more memories storing processor-executable code, and one or more processors coupled with the one or more memories and individually or collectively operable to execute the code to cause the UE to perform a method of any of aspects 1 through 14.

Aspect 30: A UE for wireless communications, comprising at least one means for performing a method of any of aspects 1 through 14.

Aspect 31: A non-transitory computer-readable medium storing code for wireless communications, the code comprising instructions executable by one or more processors to perform a method of any of aspects 1 through 14.

Aspect 32: A network entity for wireless communications, comprising one or more memories storing processor-executable code, and one or more processors coupled with the one or more memories and individually or collectively operable to execute the code to cause the network entity to perform a method of any of aspects 15 through 28.

Aspect 33: A network entity for wireless communications, comprising at least one means for performing a method of any of aspects 15 through 28.

Aspect 34: A non-transitory computer-readable medium storing code for wireless communications, the code comprising instructions executable by one or more processors to perform a method of any of aspects 15 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more processors; and
instructions stored in one or more memories and executable by the one or more processors, individually or collectively, to cause the UE to:
receive configuration information that identifies a demodulation reference signal (DMRS) pattern, the DMRS pattern associated with a starting symbol offset of a first DMRS in the DMRS pattern, a quantity of symbols between each DMRS in the DMRS pattern, and a last symbol offset of a last DMRS in the DMRS pattern;
receive a first downlink control information (DCI) that indicates a first start and length indicator value (SLIV) for a first data transmission;
receive a last DCI that indicates a last SLIV for a last data transmission that is scheduled to occur after the first data transmission; and
receive a plurality of DMRSs over a plurality of slots in accordance with the DMRS pattern, the plurality of DMRSs including the first DMRS, the last DMRS, and one or more additional DMRSs received after the first DMRS and before the last DMRS, wherein the first DMRS is received in accordance with the starting symbol offset with respect to the first SLIV, and wherein the last DMRS is received in accordance with the last symbol offset with respect to the last SLIV.

2. The UE of claim 1, wherein:
the configuration information comprises a plurality of DMRS patterns, each of the DMRS patterns of the plurality of DMRS patterns associated with respective starting symbol offsets, quantities of symbols between each DMRS, and last symbol offsets, and
the first DCI indicates the DMRS pattern of the plurality of DMRS patterns the UE is to use.

3. The UE of claim 1, wherein the first DMRS is offset in accordance with the starting symbol offset with respect to a beginning symbol indicated by the first SLIV.

4. The UE of claim 1, wherein the last DMRS is offset in accordance with the last symbol offset with respect to a last symbol indicated by the last SLIV.

5. The UE of claim 4, wherein a second to last DMRS preceding the last DMRS is separated by less than the quantity of symbols indicated by the configuration information between each DMRS in the DMRS pattern.

6. The UE of claim 1, wherein the first DCI comprises one or more fields indicating a beginning of the first data transmission and an activation of the DMRS pattern.

7. The UE of claim 1, wherein:
the first data transmission and the last data transmission are part of a data transmission burst, and
a gap of one or more slots exists in the data transmission burst.

8. The UE of claim 7, wherein the instructions are further executable by the one or more processors, individually or collectively, to cause the UE to:
receive an orphan DMRS in accordance with the DMRS pattern during the gap.

9. The UE of claim 7, wherein the DMRS pattern is a first DMRS pattern, and wherein the instructions are further executable by the one or more processors, individually or collectively, to cause the UE to:
receive one or more DMRSs in accordance with a second DMRS pattern during one or more slots indicated by a second SLIV immediately after the gap.

10. The UE of claim 9, wherein the instructions are further executable by the one or more processors, individually or collectively, to cause the UE to:
receive a third DCI comprising one or more fields indicating an activation of the second DMRS pattern.

11. The UE of claim 1, wherein the instructions are further executable by the one or more processors, individually or collectively, to cause the UE to:
receive a DMRS after the last DMRS based at least in part on the last DMRS being greater than a threshold quantity of symbols away from a last symbol indicated by the last SLIV.

12. The UE of claim 11, wherein the instructions are further executable by the one or more processors, individually or collectively, to cause the UE to:
receive a third DCI indicating the DMRS after the last DMRS, wherein a symbol position of the DMRS is indicated by the DCI.

13. The UE of claim 1, wherein the first SLIV indicates a length that spans a plurality of slots.

14. The UE of claim 1, wherein the configuration information is a radio resource control message.

15. A network entity, comprising:
one or more processors; and
instructions stored in one or more memories and executable by the one or more processors, individually or collectively, to cause the network entity to:
transmit configuration information that identifies a demodulation reference signal (DMRS) pattern, the DMRS pattern associated with a starting symbol offset of a first DMRS in the DMRS pattern, a quantity of symbols between each DMRS in the DMRS pattern, and a last symbol offset of a last DMRS in the DMRS pattern;
transmit a first downlink control information (DCI) that indicates a first start and length indicator value (SLIV) for a first data transmission;
transmit a last DCI that indicates a last SLIV for a last data transmission that is scheduled to occur after the first data transmission; and
transmit a plurality of DMRSs over a plurality of slots in accordance with the DMRS pattern, the plurality of DMRSs including the first DMRS, the last DMRS, and one or more additional DMRSs received after the first DMRS and before the last DMRS, wherein the first DMRS is received in accordance with the starting symbol offset with respect to the first SLIV, and wherein the last DMRS is transmitted in accordance with the last symbol offset with respect to the last SLIV.

16. The network entity of claim 15, wherein:
the configuration information comprises a plurality of DMRS patterns, each of the DMRS patterns of the plurality of DMRS patterns associated with respective starting symbol offsets, quantities of symbols between each DMRS, and last symbol offsets, and
the first DCI indicates the DMRS pattern of the plurality of DMRS patterns a user equipment is to use.

17. The network entity of claim 15, wherein the first DMRS is offset in accordance with the starting symbol offset with respect to a beginning symbol indicated by the first SLIV.

18. The network entity of claim 15, wherein the last DMRS is offset in accordance with the last symbol offset with respect to a last symbol indicated by the last SLIV.

19. The network entity of claim 18, wherein a second to last DMRS preceding the last DMRS is separated by less than the quantity of symbols indicated by the configuration information between each DMRS in the DMRS pattern.

20. The network entity of claim 15, wherein the first DCI comprises one or more fields indicating a beginning of the first data transmission and an activation of the DMRS pattern.

21. The network entity of claim 15, wherein:
the first data transmission and the last data transmission are part of a data transmission burst, and
a gap of one or more slots exists in the data transmission burst.

22. The network entity of claim 21, wherein the instructions are further executable by the one or more processors, individually or collectively, to cause the network entity to:
transmit an orphan DMRS in accordance with the DMRS pattern during the gap.

23. The network entity of claim 21, wherein the DMRS pattern is a first DMRS pattern, and wherein the instructions are further executable by the one or more processors, individually or collectively, to cause the network entity to:
transmit one or more DMRSs in accordance with a second DMRS pattern during one or more slots indicated by a second SLIV immediately after the gap.

24. The network entity of claim 23, wherein the instructions are further executable by the one or more processors, individually or collectively, to cause the network entity to:
transmit a third DCI comprising one or more fields indicating an activation of the second DMRS pattern.

25. The network entity of claim 15, wherein the instructions are further executable by the one or more processors, individually or collectively, to cause the network entity to:
transmit a DMRS after the last DMRS based at least in part on the last DMRS being greater than a threshold quantity of symbols away from a last symbol indicated by the last SLIV.

26. The network entity of claim 25, wherein the instructions are further executable by the one or more processors, individually or collectively, to cause the network entity to:
transmit a third DCI indicating the DMRS after the last DMRS, wherein a symbol position of the DMRS is indicated by the DCI.

27. The network entity of claim 15, wherein the first SLIV indicates a length that spans a plurality of slots.

28. The network entity of claim 15, wherein the configuration information is a radio resource control message.

29. A method for wireless communications at a user equipment (UE), comprising:
receiving configuration information that identifies a demodulation reference signal (DMRS) pattern, the DMRS pattern associated with a starting symbol offset of a first DMRS in the DMRS pattern, a quantity of symbols between each DMRS in the DMRS pattern, and a last symbol offset of a last DMRS in the DMRS pattern;
receiving a first downlink control information (DCI) that indicates a first start and length indicator value (SLIV) for a first data transmission;
receiving a last DCI that indicates a last SLIV for a last data transmission that is scheduled to occur after the first data transmission; and
receiving a plurality of DMRSs over a plurality of slots in accordance with the DMRS pattern, the plurality of DMRSs including the first DMRS, the last DMRS, and one or more additional DMRSs received after the first DMRS and before the last DMRS, wherein the first DMRS is received in accordance with the starting symbol offset with respect to the first SLIV, and wherein the last DMRS is received in accordance with the last symbol offset with respect to the last SLIV.

30. A method for wireless communications at a network entity, comprising:
transmitting configuration information that identifies a demodulation reference signal (DMRS) pattern, the DMRS pattern associated with a starting symbol offset of a first DMRS in the DMRS pattern, a quantity of symbols between each DMRS in the DMRS pattern, and a last symbol offset of a last DMRS in the DMRS pattern;
transmitting a first downlink control information (DCI) that indicates a first start and length indicator value (SLIV) for a first data transmission;
transmitting a last DCI that indicates a last SLIV for a last data transmission that is scheduled to occur after the first data transmission; and
transmitting a plurality of DMRSs over a plurality of slots in accordance with the DMRS pattern, the plurality of DMRSs including the first DMRS, the last DMRS, and one or more additional DMRSs received after the first DMRS and before the last DMRS, wherein the first DMRS is received in accordance with the starting symbol offset with respect to the first SLIV, and wherein the last DMRS is transmitted in accordance with the last symbol offset with respect to the last SLIV.
